(19) United States
(12) Patent Application Publication
(10) Pub. No.: US 2025/0079567 A1
(43) Pub. Date: Mar. 6, 2025

(54) IMMERSION COOLING SYSTEMS FOR TRACTION BATTERY PACKS

(71) Applicant: FORD GLOBAL TECHNOLOGIES, LLC, Dearborn, MI (US)

(72) Inventor: Xiaogang Zhang, Novi, MI (US)

(21) Appl. No.: 18/461,633

(22) Filed: Sep. 6, 2023

(51) Int. Cl. H01M 10/6568; H01M 10/613; H01M 10/625; H01M 10/63; H01M 50/209; H01M 50/258; H01M 50/291

(52) U.S. Cl. CPC H01M 10/6568; H01M 10/613; H01M 10/625; H01M 10/63; H01M 50/209; H01M 50/258; H01M 50/291; B60L 50/64; B60L 58/26; H01M 2220/20

(57) ABSTRACT

Immersion cooling systems are provided for traction battery packs. An exemplary immersion cooling system may include an intake manifold, an exhaust manifold, a first intake runner fluidly connected to the intake manifold and a first interior volume of a compartmentalized battery module, and a first exhaust runner fluidly connected to the exhaust manifold and the first interior volume. A cooling fluid (e.g., a dielectric) may be selectively communicated through the first interior volume for thermally managing the battery module. A flow control valve may be positioned within the first intake runner for controlling the flow through the first interior volume, and a control module may control a position of the valve based at least on a temperature of the cooling fluid exiting the first interior volume.

### TECHNICAL FIELD

This disclosure relates generally to electrified vehicle traction battery packs, and more particularly to immersion cooling systems capable of managing thermal energy levels within traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first battery module including a first interior volume, and an immersion cooling system for thermally managing the first battery module. The immersion cooling system includes an intake manifold, an exhaust manifold, a first intake runner fluidly connected to the intake manifold and the first interior volume, and a first exhaust runner fluidly connected to the exhaust manifold and the first interior volume.

In a further non-limiting embodiment of the foregoing traction battery pack, a second battery module includes a second interior volume that is fluidly isolated from the first interior volume.

In a further non-limiting embodiment of either of the foregoing traction battery packs, the immersion cooling system includes a second intake runner fluidly connected to the intake manifold and the second interior volume, and a second exhaust runner fluidly connected to the exhaust manifold and the second interior volume.

In a further non-limiting embodiment of any of the foregoing traction battery packs, a first flow control valve is positioned within the first intake runner, and a second flow control valve is positioned within the second intake runner.

In a further non-limiting embodiment of any of the foregoing traction battery packs, a first temperature sensor is positioned within or near the first exhaust runner, and a second temperature sensor positioned within or near the second exhaust runner.

In a further non-limiting embodiment of any of the foregoing traction battery packs, a first flow control valve is positioned within the first intake runner, and a first temperature sensor is positioned within or near the first exhaust runner.

In a further non-limiting embodiment of any of the foregoing traction battery packs, the immersion cooling system is configured to circulate a dielectric fluid through the first interior volume.

In a further non-limiting embodiment of any of the foregoing traction battery packs, the immersion cooling system further includes a reservoir that is fluidly connected to the intake manifold.

In a further non-limiting embodiment of any of the foregoing traction battery packs, the immersion cooling system further includes a liquid-gas separator fluidly connected to the exhaust manifold.

In a further non-limiting embodiment of any of the foregoing traction battery packs, the immersion cooling system further includes a pump configured to circulate a dielectric fluid through the intake manifold.

In a further non-limiting embodiment of any of the foregoing traction battery packs, the first battery module includes a plurality of battery cells that are housed within an outer housing that includes a plurality of plates.

In a further non-limiting embodiment of any of the foregoing traction battery packs, at least one plate of the plurality of plates includes a battery cell holder arranged to maintain a spaced relationship between the plurality of battery cells.

A traction battery pack according to another exemplary aspect of the present disclosure includes, among other things, a first battery module that includes a plurality of battery cells arranged within a first interior volume, an intake manifold configured to receive a cooling fluid, a first intake runner fluidly connected to the intake manifold and the first interior volume, a first exhaust runner fluidly connected to the first interior volume and an exhaust manifold, a first flow control valve configured to control a flow of the cooling fluid through the first interior volume, and a control module programmed to control a position of the first flow control valve based on a temperature of the cooling fluid exiting the first interior volume through the first exhaust runner.

In a further non-limiting embodiment of the foregoing traction battery pack, a second battery module includes a second interior volume that is fluidly isolated from the first interior volume.

In a further non-limiting embodiment of either of the foregoing traction battery packs, a second intake runner fluidly connects to the intake manifold and the second interior volume, and a second exhaust runner fluidly connects to the exhaust manifold and the second interior volume.

In a further non-limiting embodiment of any of the foregoing traction battery packs, a second flow control valve is configured to control a flow of the cooling fluid through the second interior volume.

In a further non-limiting embodiment of any of the foregoing traction battery packs, the control module is further programmed to control a position of the second flow control valve based on a temperature of the cooling fluid exiting the second interior volume through the second exhaust runner.

In a further non-limiting embodiment of any of the foregoing traction battery packs, a temperature sensor is positioned within or near the first exhaust runner and is configured to sense the temperature.

In a further non-limiting embodiment of any of the foregoing traction battery packs, the control module is further programmed to control a speed of a pump based on the temperature.

In a further non-limiting embodiment of any of the foregoing traction battery packs, the cooling fluid is a dielectric fluid.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates an immersion cooling system for a traction battery pack.

FIG. 3 illustrates an exemplary battery module of the traction battery pack of FIG. 2.

FIG. 4 illustrates a top plate of an outer housing of the battery module of FIG. 3.

FIG. 5 illustrates a bottom plate of an outer housing of the battery module of FIG. 3.

FIG. 6 illustrates a first end plate an outer housing of the battery module of FIG. 3.

FIG. 7 illustrates a second end plate of an outer housing of the battery module of FIG. 3.

### DETAILED DESCRIPTION

This disclosure details immersion cooling systems for managing thermal energy levels of traction battery packs. An exemplary immersion cooling system may include an intake manifold, an exhaust manifold, a first intake runner fluidly connected to the intake manifold and a first interior volume of a compartmentalized battery module, and a first exhaust runner fluidly connected to the exhaust manifold and the first interior volume. A cooling fluid (e.g., a dielectric) may be selectively communicated through the first interior volume for thermally managing the battery module. A flow control valve may be positioned within the first intake runner for controlling the flow through the first interior volume, and a control module may control a position of the valve based at least on a temperature of the cooling fluid exiting the first interior volume. These and other features are discussed in greater detail in the following paragraphs of this detailed description.

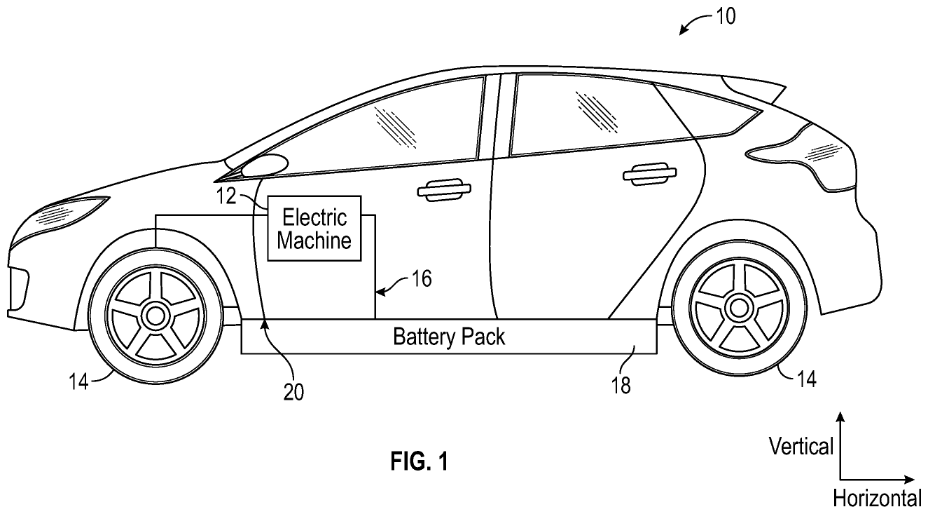

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

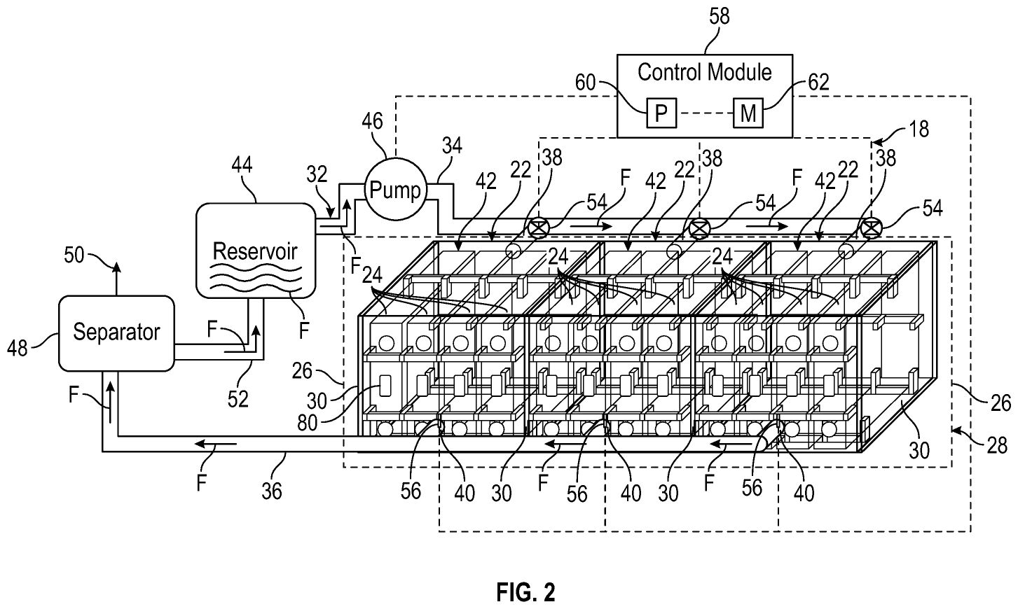

FIG. 2 illustrates additional details associated with the traction battery pack 18 of the electrified vehicle 10 of FIG. 1. The traction battery pack 18 may include a plurality of battery modules 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery modules 22 and battery cells 24 provided within the traction battery pack 18 is not intended to limit this disclosure.

In an embodiment, the battery cells 24 of each battery module 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery modules 22 may be arranged in on or more rows inside the traction battery pack 18. In an embodiment, the traction battery pack 18 includes three battery modules 22, and each battery module 22 includes four battery cells 24 (for a total of twelve battery cells 24). However, other configurations are possible, and therefore the traction battery pack 18 could include a greater or fewer number of battery modules and battery cells within the scope of this disclosure.

The battery modules 22 and various other battery internal components (e.g., bussed electrical center, battery electric control module, wiring, connectors, etc.) may be housed inside of an enclosure assembly 28 of the traction battery pack 18. Although shown schematically, the enclosure assembly 28 could embody a single-piece design or multi-piece design (e.g., enclosure cover and enclosure tray that are joined together to establish an interior for housing the battery modules 22). The size, shape, and overall configuration of the enclosure assembly 28 is not intended to limit this disclosure. In an embodiment, the enclosure assembly 28 provides a sealed enclosure around the battery modules 22 and other battery internal components of the traction battery pack 18. The enclosure assembly 28 therefore provides outermost surfaces of the traction battery pack 18.

Each battery module 22 is compartmentalized and therefore fluidly isolated from the other battery modules 22 of the traction battery pack 18. Accordingly, gases, effluent particles, and/or other vent byproducts vented by one of the battery cells 24 of one of the battery modules 22 cannot flow directly to another of the battery modules 22.

Each battery module 22 may be spaced apart from the other battery modules 22 of the traction battery pack 18. For example, the battery modules 22 may be separated from one another by their respective housings and an insulation shield 30 disposed between the housings. Additional insulation shields 30 may be positioned between outboard-most battery modules 22 and end walls 26 of the enclosure assembly 28. The insulation shields 30 may be configured to block the transfer of thermal energy from one battery module 22 to another. The insulation shields 30 may further provide a desired level of compressibility for more easily positioning the battery modules 22 within the enclosure assembly 28. The insulation shields 30 may be made of mica, aerogels, or any other suitable material or combinations of materials.

The traction battery pack 18 may additionally include an immersion cooling system 32. As further explained below, the immersion cooling system 32 may provide a closed loop flow circuit for thermally managing the battery modules 22 and/or other electrical components of the traction battery pack 18.

The immersion cooling system 32 may be configured for directly contacting individual surfaces of the battery cells 24 by introducing a cooling fluid F inside each battery module 22. In an embodiment, the cooling fluid F is a dielectric fluid. However, other fluids could be utilized within the scope of this disclosure.

The immersion cooling system 32 may include an intake manifold 34, an exhaust manifold 36, a plurality of intake runners 38, and a plurality of exhaust runners 40. The intake manifold 34 and the exhaust manifold 36 may each extend outside the enclosure assembly 28 of the traction battery pack 18, and at least a portion of the intake runners 38 and the exhaust runners 40 may extend into the interior of the enclosure assembly 28. The intake runners 38 may be fluidly connected to the intake manifold 34, and the exhaust runners 40 may be fluidly connected to the exhaust manifold 36. Each intake runner 38 and each exhaust runner 40 may further be fluidly connected to an interior volume 42 of one of the battery modules 22.

The intake manifold 34 may be fluidly connected to a reservoir 44 that can store the cooling fluid F. A pump 46 may be operated to selectively force the cooling fluid F through the intake manifold 34. As schematically shown, the reservoir 44 and the pump 46 may both be located outside of the enclosure assembly 28 of the traction battery pack 18.

The cooling fluid F may be selectively communicated from the reservoir 44 through the intake manifold 34 before being separated into the multiple intake runners 38. The cooling fluid F may then separately enter the interior volume 42 of each battery module 22 through the intake runners 38. The cooling fluid F may pick up heat from the battery cells 24 through convective heat transfer as it flows through the interior volume 42 of each battery module 22, thereby carrying away excessive heat and stabilizing the temperatures of the battery cells 24.

The cooling fluid F may exit each battery module 22 through the exhaust runners 40 before merging within the exhaust manifold 36. The exhaust manifold 36 may be fluidly connected to a liquid-gas separator 48. Gas may be separated from the cooling fluid F within the liquid-gas separator 48 and may be exhausted to atmosphere as schematically shown at arrow 50. As schematically shown, the liquid-gas separator 48 may be located outside of the enclosure assembly 28 of the traction battery pack 18. The degassed cooling fluid F may be returned to the reservoir 44 as part of a closed loop flow circuit via a connection line 52 that is fluidly connected to both the liquid-gas separator 48 and the reservoir 44.

The immersion cooling system 32 may further include a plurality of flow control valves 54, a plurality of temperature sensors 56, and a control module 58. Each flow control valve 54 may be configured to control the flow of the cooling fluid F into one of the battery modules 22. In an embodiment, one flow control valve 54 is provided within or near each intake runner 38 for controlling the fluid flow. However, other configurations are contemplated within the scope of this disclosure. Each flow control valve 54 may be a multi-position solenoid valve or any other suitable type of valve.

The temperature sensors 56 may be configured to sense the temperature of the cooling fluid F. In an embodiment, one temperature sensor 56 is provided within or near each exhaust runner 40. The temperature sensors 56 may therefore be arranged to sense the temperature of the cooling fluid F as it exits each battery module 22.

The control module 58 may be operably connected to the pump 46, the flow control valves 54, and the temperature sensors 56 and may be programmed to control operations of the immersion cooling system 32 for thermally managing the traction battery pack 18. The control module 58 may include both hardware and software and could be part of an overall vehicle control system, such as a vehicle system controller (VSC), or could alternatively be a stand-alone controller or collection of controllers that are separate from the VSC. It should therefore be understood that the control module 58 and one or more additional controllers operably coupled thereto can collectively be referred to as a “control module” within the scope of this disclosure.

The control module 58 may be programmed with executable instructions for interfacing with and commanding operation of various components of the immersion cooling system 32 as part of a control strategy for controlling a flow rate of the cooling fluid F through each individual battery module 22. The control module 58 may include a processor 60 and non-transitory memory 62 for executing the various control strategies and modes associated with the immersion cooling system 32. The processor 60 may be a custom made or commercially available processor, a central processing unit (CPU), or generally any device for executing software instructions. The memory 62 may include any one or combination of volatile memory elements and/or nonvolatile memory elements. The processor 60 may be operably coupled to the memory 62 and may be configured to execute one or more programs stored in the memory 62 based on the various inputs received from other devices (e.g., the temperature sensors 56) associated with the immersion cooling system 32.

The control module 58 may be programmed to control the flow rate of the cooling fluid F for thermally managing the battery cells 24 and/or for responding to a battery thermal event that could occur within one or more of the battery modules 22. A battery thermal event may occur, for example, during over-charging conditions, over-discharging conditions, or other conditions and can cause one or more of the battery cells 24 to expel battery vent byproducts which can include gases, effluent particles, and/or other vent byproducts.

The temperature sensors 56 may periodically provide input signals to the control module 58 that are indicative of the temperature of the cooling fluid F exiting each battery module 22. In response to receiving the input signals, the control module 58 may control operations of the pump 46 and the flow control valves 54 in order to achieve a desired flow rate of the cooling fluid F though each respective battery module 22. For example, when the temperature input signals for one of the respective battery modules 22 indicate a temperature that is below a first predefined temperature threshold (e.g., about 60 degrees C.), the control module 58 may command the pump 46 and the flow control valve 54 associated with that respective battery module 22 to operate in a manner appropriate for achieving a first or “low” flow rate. Notably, “low” flow rates could include zero flow through the respective battery module 22 during some conditions. When the temperature input signals for one of the respective battery modules 22 indicate a temperature that is greater than a second predefined temperature threshold (e.g., about 100 degrees C.), the control module 58 may command the pump 46 and the flow control valve 54 associated with that respective battery module 22 to operate in a manner appropriate for achieving a second or “high” flow rate. Further, when the temperature input signals associated within one of the respective battery modules 22 indicate a temperature that is between the first and second predefined temperature thresholds, the control module 58 may command the pump 46 and the flow control valve 54 associated with the respective battery module 22 to operate in a manner appropriate for achieving a third or “intermediate” flow rate.

Controlling operations of the pump 46 may include adjusting a speed of the pump 46, and controlling operations of each flow control valve 54 may include controlling an opening percentage of the valve. In this way, the flow rate of the cooling fluid F can be individually controlled with respect to each battery module 22.

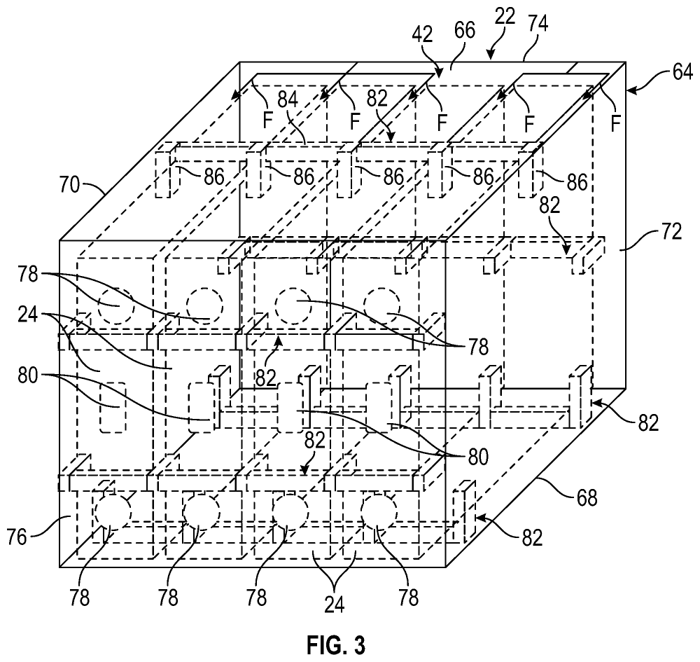

FIG. 3 illustrates an exemplary design of a battery module 22 of the traction battery pack 18 of FIGS. 1 and 2. Each battery module 22 of the traction battery pack 18 may include an identical design to the battery module 22 shown in FIG. 3, or a similar design as its electrical connections with neighboring battery modules can vary in order to completely a necessary electrical circuit of the traction battery pack 18.

The battery module 22 includes a plurality of battery cells 24 housed within an outer housing 64. The outer housing 64 may be configured as a six-sided box-like structure that include a top plate 66, a bottom plate 68, a first side plate 70, a second side plate 72, a first end plate 74, and a second end plate 76. The top plate 66, the bottom plate 68, the first side plate 70, the second side plate 72, the first end plate 74, and the second end plate 76 may be connected together to establish the interior volume 42. The battery cells 24 may be positioned within the interior volume 42.

The battery cells 24 may be arranged such that major sides of the cells extend in parallel with the first and second side plates 70, 72, and minor sides of the cells extend in parallel with the first and second end plates 74, 76. The battery cells 24 may further be arranged such that terminals 78 and a vent port 80 of each battery cell 24 faces downstream (e.g., toward the exhaust manifold 36 and away from the intake manifold 34). The battery cells 24 may thus be considered to be “side-oriented” within the outer housing 64.

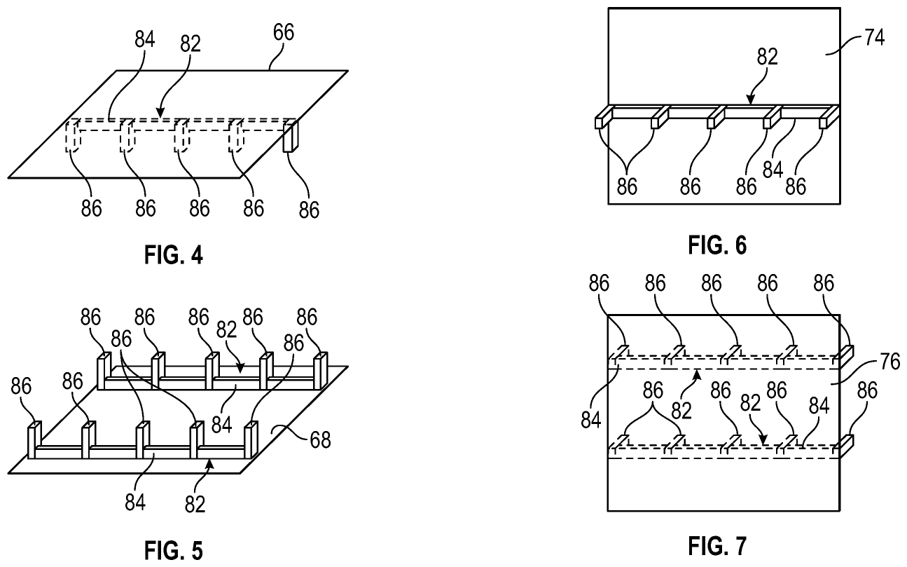

Referring now to FIGS. 3-7, at least a portion of the substituent plates of the outer housing 64 of battery module 22 may include one or more battery cell holders 82. The battery cell holders 82 may be configured to at least partially separate the battery cells 24 from one another and retain their spaced relationship within the interior volume 42. The battery cell holders 82 may be configured to exert a relatively small amount of compression upon the battery cells 24 in order to maintain their positions inside the outer housing 64 of the battery module 22.

In the illustrated embodiment, the top plate 66 and the first end plate 74 of the outer housing 64 are each equipped with one battery cell holder 82, the bottom plate 68 and the second end plate 76 of the outer housing 64 are each equipped with two battery cell holders 82, and the first and second side plates 70, 72 are not equipped with any battery cell holders 82. However, other configurations of the outer housing 64 are contemplated within the scope of this disclosure.

Each battery cell holder 82 may include a base 84 and a plurality of spacer fingers 86 that protrude outwardly from the base 84. The base 84 may be secured (e.g., welded, adhered, etc.) to an interior surface of one of the plates of the outer housing 64. The spacer fingers 86 may be arranged to extend between adjacent battery cells 24 for maintaining a gapped relationship therebetween. Outboard spacer fingers 86 of the battery cell holder 82 may be arranged to extend between outermost battery cells 24 and the outer housing 64 for maintaining a gapped relationship therebetween. When the cooling fluid F is introduced into the interior volume 42 of the battery module 22, the cooling fluid F may flow over and around each battery cell 24 and between the battery cells 24 and the outer housing 64, including within the various gaps established by the battery cell holders 82. The cooling fluid F may therefore contact all battery cell 24 surfaces, thereby improving convective heat transfer and more quickly quelling vent gases during battery thermal events.

The spacer fingers 86 may be designed to extend far enough into the gaps between the battery cells 24 for providing an adequate holding force while avoiding blocking the flow path of the cooling fluid F. In an embodiment, the length of each spacer finger 86 is about ⅛ of the length of the major side of the battery cell 24. However, other configurations are contemplated within the scope of this disclosure.

Some of the battery cell holders 82 may be arranged to avoid interference with other components and/or to perform specific functions. For example, the battery cell holders 82 of the second end plate 76 may be arranged to either side of the vent ports 80 of the battery cells 24 to avoid venting interference, and the battery cells holders 82 of the bottom plate 68 may be spaced apart a sufficient distance for adequately balancing the battery cells 24.

The exemplary traction battery packs of this disclosure include an immersion cooling system for providing enhanced battery cell thermal management. A cooling fluid flow rate may be optimized for each individual battery module of the traction battery pack by providing a compartmentalized design, thereby maximizing heat transfer from battery surfaces to the cooling fluid and more quickly quelling vent gas temperature spikes during thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first battery module including a first interior volume; and
an immersion cooling system for thermally managing the first battery module, wherein the immersion cooling system includes an intake manifold, an exhaust manifold, a first intake runner fluidly connected to the intake manifold and the first interior volume, and a first exhaust runner fluidly connected to the exhaust manifold and the first interior volume.

2. The traction battery pack as recited in claim 1, comprising a second battery module including a second interior volume that is fluidly isolated from the first interior volume.

3. The traction battery pack as recited in claim 2, wherein the immersion cooling system includes a second intake runner fluidly connected to the intake manifold and the second interior volume, and a second exhaust runner fluidly connected to the exhaust manifold and the second interior volume.

4. The traction battery pack as recited in claim 3, comprising a first flow control valve positioned within the first intake runner, and a second flow control valve positioned within the second intake runner.

5. The traction battery pack as recited in claim 3, comprising a first temperature sensor positioned within or near the first exhaust runner, and a second temperature sensor positioned within or near the second exhaust runner.

6. The traction battery pack as recited in claim 1, comprising a first flow control valve positioned within the first intake runner, and a first temperature sensor positioned within or near the first exhaust runner.

7. The traction battery pack as recited in claim 1, wherein the immersion cooling system is configured to circulate a dielectric fluid through the first interior volume.

8. The traction battery pack as recited in claim 1, wherein the immersion cooling system further includes a reservoir that is fluidly connected to the intake manifold.

9. The traction battery pack as recited in claim 1, wherein the immersion cooling system further includes a liquid-gas separator fluidly connected to the exhaust manifold.

10. The traction battery pack as recited in claim 1, wherein the immersion cooling system further includes a pump configured to circulate a dielectric fluid through the intake manifold.

11. The traction battery pack as recited in claim 1, wherein the first battery module includes a plurality of battery cells housed within an outer housing that includes a plurality of plates.

12. The traction battery pack as recited in claim 11, wherein at least one plate of the plurality of plates includes a battery cell holder arranged to maintain a spaced relationship between the plurality of battery cells.

13. A traction battery pack, comprising:
a first battery module that includes a plurality of battery cells arranged within a first interior volume;
an intake manifold configured to receive a cooling fluid;
a first intake runner fluidly connected to the intake manifold and the first interior volume;
a first exhaust runner fluidly connected to the first interior volume and an exhaust manifold;
a first flow control valve configured to control a flow of the cooling fluid through the first interior volume; and
a control module programmed to control a position of the first flow control valve based on a temperature of the cooling fluid exiting the first interior volume through the first exhaust runner.

14. The traction battery pack as recited in claim 13, comprising a second battery module including a second interior volume that is fluidly isolated from the first interior volume.

15. The traction battery pack as recited in claim 14, comprising a second intake runner fluidly connected to the intake manifold and the second interior volume, and a second exhaust runner fluidly connected to the exhaust manifold and the second interior volume.

16. The traction battery pack as recited in claim 15, comprising a second flow control valve configured to control a flow of the cooling fluid through the second interior volume.

17. The traction battery pack as recited in claim 16, wherein the control module is further programmed to control a position of the second flow control valve based on a temperature of the cooling fluid exiting the second interior volume through the second exhaust runner.

18. The traction battery pack as recited in claim 13, comprising a temperature sensor positioned within or near the first exhaust runner and configured to sense the temperature.

19. The traction battery pack as recited in claim 13, wherein the control module is further programmed to control a speed of a pump based on the temperature.

20. The traction battery pack as recited in claim 13, wherein the cooling fluid is a dielectric fluid.
